(19) United States
(12) Patent Application Publication
(10) Pub. No.: US 2009/0055451 A1
(43) Pub. Date: Feb. 26, 2009

(54) Systems and Methods For Providing Redundant Data Storage

(76) Inventors: Clay Andre Reimer, St. John's (CA); Shannon Brentley Hill, Greensboro, NC (US)

Correspondence Address: KILPATRICK STOCKTON LLP, 1001 WEST FOURTH STREET, WINSTON-SALEM, NC, 27101, US

(21) Appl. No.: 12/191,992

(22) Filed: Aug. 14, 2008

Related U.S. Application Data
(60) Provisional application No. 60/956,403, filed on Aug. 17, 2007.

(51) Int. Cl. G06F 12/02; G06F 12/00

(52) U.S. Cl. 707/205; 707/E17.01; 707/E17.032

(57) ABSTRACT

Embodiments of systems, methods, and computer-readable media for providing redundant data storage are disclosed. For example, one embodiment of the present invention is a method including the steps of receiving a first signal comprising a request to store a file; generating a plurality of data blocks comprising portions of the file; computing a plurality of parity blocks based at least in part on the plurality of data blocks; and transmitting at least some of the plurality of data blocks and at least some of the plurality of parity blocks to a channel unit. In another embodiment, a computer-readable media comprises code for a carrying out such a method.

### CROSS-REFERENCES TO RELATED APPLICATION

This application claims priority to U.S. Provisional Patent Application No. 60/956,403 entitled “Systems and Methods for Providing Redundant Data Storage,” filed Aug. 17, 2007, the entirety of which is incorporated herein by reference.

### FIELD OF THE INVENTION

The present invention generally relates to data storage, and more specifically relates to redundant data storage.

### BACKGROUND

Conventional data storage systems allow a user to store data files to a non-volatile computer-readable medium, such as a hard disk, to allow the user to retrieve and use the data again at a later time. For example, a user of a word processing program may save a word processor document on a local hard drive for later use. However, if the hard drive fails, the user will likely lose any data stored on the hard drive. Thus, it may be desirable to provide a system that can allow a user to store a data file in a redundant, fault-tolerant data storage system.

### SUMMARY

Embodiments of the present invention comprise systems, methods, and computer-readable media for providing redundant data storage. For example, one embodiment of the present invention is a method comprising the steps of receiving a first signal comprising a request to store a file; generating a plurality of data blocks comprising portions of the file; computing a plurality of parity blocks based at least in part on the plurality of data blocks; and transmitting at least some of the plurality of data blocks and at least some of the plurality of parity blocks to a channel unit. In another embodiment, a computer-readable media comprises code for a carrying out such a method.

These illustrative embodiments are mentioned not to limit or define the invention, but to provide examples to aid understanding thereof. Illustrative embodiments are discussed in the Detailed Description, and further description of the invention is provided there. Advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 shows a system for providing redundant data storage according to one embodiment of the present invention; and

FIGS. 2-5 show methods for providing redundant data storage according to embodiments of the present invention.

### DETAILED DESCRIPTION

Embodiments of the present invention provide systems and methods for providing redundant data storage.

### Illustrative Redundant Data Storage

For some businesses, it may be desirable to use a data storage solution that is available from a remote location, provides redundant, fault-tolerant storage and also provides for data recovery even after the loss of a storage location, such as to power or network failure or a natural disaster. For example, one embodiment of the present invention may allow a user to access a system for providing redundant data storage from a personal computer over the Internet. The user may select a file to be saved and drag the file to a folder associated with the system for redundant data storage. This action may cause a message to be sent to server, referred to as a transport, requesting to store the file in the system for redundant data storage. The transport determines whether the user has sufficient access privileges to store the data file, and, if so, whether the user has sufficient storage space allocated to store the file. If the transport determines that the file may be stored in the system, the file is transferred from the user's computer to the transport, which breaks the file into a series of data blocks. The transport then computes a number of parity blocks based on the data blocks. The data blocks and parity blocks are then transmitted to 2 or more different channel units, which then store the data and/or parity blocks they receive on computer-readable media.

When the user attempts to retrieve the file at a later time, the user's computer transmits a request for the file to the transport, which reads metadata describing how and where the data and parity blocks created from the file were stored, requests the data and parity blocks from the appropriate channel units, and rebuilds the file from the data blocks. If one or more of the channel units is unavailable, the transport reconstructs any missing data blocks based on the received data blocks and parity blocks. The reconstructed file is then transmitted to the user.

The preceding description of an illustrative embodiment is intended to introduce the reader to the general subject matter disclosed herein, but is not intended to limit the scope of the invention in any way.

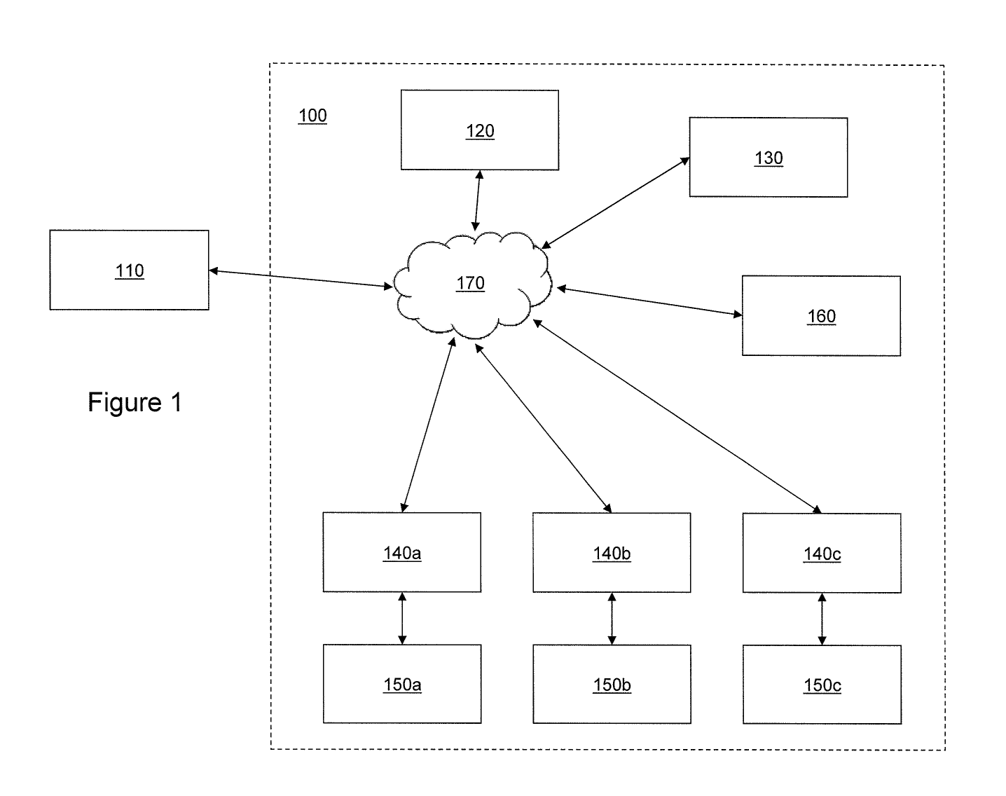

Referring now to FIG. 1, FIG. 1 shows a system 100 for providing redundant data storage. The system 100 comprises a storage transport 120 (or “transport”), a storage controller 130 (or “controller”), three channel units 140a-c, three storage units 150a-c, and a caching server 160. The system further comprises a network 170 in communication with the storage transport 120, the storage controller 130, the channel units 140a-c, and the caching server 160. In this illustrative embodiment, each of the channel units 140a-c is connected to one storage unit 150a-c. A client computer 110, which is not part of the redundant data storage system, is also shown.

In the embodiment shown in FIG. 1, to provide for storing data files in the system 100, the transport 120 is configured to receive data files, break the data files into a plurality of data blocks and parity blocks, and send the data blocks and parity blocks to the channel units 140a-c for storage. For example, in the embodiment shown in FIG. 1, the transport 120 is configured to receive a signal comprising a request to store a file, determine a storage configuration of the system 100, and receive the data file.

The request to store the file may comprise one or more data items, such as a user name, a password, a filename and a file size. The transport 120 may then determine if the user name and password are correct, if the user name has sufficient privileges and sufficient storage is allocated to the user to store the data file in the system, and if the system has enough storage space available to store the data file. After analyzing the request, the transport 120 may transmit a signal in response to the request indicating that the transport 120 is ready to store the file. Alternatively, the transport 120 may respond to the request with a message that the data file cannot be stored in the system. Such a response may include additional information, such as a reason for the denial of the request.

Once the transport 120 begins to receive the data file to be stored, the transport 120 is configured to generate a plurality of data blocks comprising portions of the data file, and to compute a plurality of data blocks. This process is described in greater detail below, but in this embodiment, as the data file is being received, the transport 120 generates data blocks by breaking the data file into a series of equally-sized data blocks. For example, in this embodiment, the transport breaks the file into a series of 1024 byte (or 1 kilobyte, or 1 K) blocks. In other embodiments, data blocks of different sizes may be used, or data blocks with variable sizes may be used. In some cases, a file may not be evenly divisible into an integer number of data blocks. In such a case, the transport may fill the remaining bytes of a data block having less than the designated number of data bytes with 0's to ensure all data blocks have the same number of bytes of data. In one embodiment, the transport 120 may not fill the data block with additional data to bring it to the same size as the other data blocks.

The transport 120 is further configured to assign data blocks and parity blocks to the channel units 140a-c, and to transmit the data blocks and parity blocks to the appropriate channel units 140a-c. In addition, the transport generates a metadata file that describes attributes of the data file, such as the size of the data file, and the channel units on which blocks of the data file are stored. In this embodiment, the metadata file is stored on each channel unit 140a-c for use during retrieval of the data file, though in other embodiments, it may be stored in another location.

The embodiment shown in FIG. 1 is also capable of retrieving a data file from the channel units 140a-c in response to a request for the data file. The transport 120 is configured to receive a signal comprising a request to retrieve a file. In this embodiment, the request comprises information including a user name, a password, and a name of a data file to be retrieved. Upon receipt of the request, the transport 120 is configured to determine whether the user name and password are correct, whether the user name has sufficient privileges to retrieve the data file, and whether the data file exists within the system 100.

If the transport 120 determines that the file should be retrieved, it transmits a signal to each of the channel units 140a-c requesting the metadata file associated with the data file. Otherwise, the transport 120 transmits a message indicating that the request was denied. Such a message may include additional information, such as a reason for the denial.

After receiving the metadata files, the transport 120 transmits a second signal to each of the channel units 140a-c requesting the data blocks and parity blocks stored by each channel unit 140a-c. After receiving the data blocks and parity blocks, the transport 120 generates the data file based at least in part on the data blocks. The parity blocks may be used by the transport 120 to reconstruct a file if one or more data blocks are corrupted or unavailable. For example, if a channel unit is not available, the requested data file may be reconstructed based at least in part on the retrieved data blocks and the retrieved parity blocks as will be described in greater detail below.

After the transport 120 has generated the data file, the transport 120 transmits a signal comprising the data file to the client 110.

In the embodiment shown in FIG. 1, caching server may be employed to aid in the retrieval of data files. For example, a data file may be requested a large number of times in a short period of time. In the embodiment shown in FIG. 1, the system provides two levels of caching for some data files. The first level of caching is triggered when a data file having a file size of greater than 5 megabytes (MB) is accessed more than 10 times in one hour. In such a case, a reconstructed copy of the data file is stored on the transport 120. This may increase the speed at which the data file can be retrieved from the system 100. In such a case, the data file does not need to be reconstructed each time it is requested; it is already available on the transport server 120.

The second level of caching is triggered if a data file having a file size of greater than 5 MB is accessed more than 100 times in an hour. In such a case, a copy of the reconstructed data file is transmitted to the caching server 160. In this embodiment, the caching server is provided by a third party content delivery provider, such as Akamai Technologies, Inc, and may comprise a plurality of servers. In other embodiments, the second level of caching may be provided by the client 110 or a server (or servers) at the client's location or data center.

While the caching functionality described above is used in the embodiment shown in FIG. 1, some embodiments may employ different caching schemes. For example, in one embodiment, a system for providing redundant data storage may comprise one level of caching. In such an embodiment, the system may only provide caching by the transport server. In one embodiment, a system for providing redundant data storage may comprise different thresholds or triggers for caching functionality. For example, a connection between a transport 120 and a network 170 may comprise a high bandwidth connection. In such an embodiment, a second level of caching may not be employed until a file has been requested 10,000 times in one hour. Still further variations are possible and may be configured by an administrator of a system for providing redundant data storage, or may be configured automatically based upon network conditions, transport load conditions, or other factors.

In the embodiment shown in FIG. 1, the controller 130 provides management functionality for the system 100. The controller 130 keeps track of how many channel units 140a-c are connected to the system, information necessary to communicate with the channel units (such as an IP address), and the status of the channel units 140a-c. For example, the controller 130 creates a configuration file for the transport 120 that identifies that three channel units 140a-c are connected to the system 100, the IP address for each channel unit 140a-c, and the status of the channel unit 140a-c. The controller can also detect the addition of new channel units, and the removal or failure of connected channel units 140a-c. For example, the controller 130 may receive a message from a new channel unit, or it may not receive a response from an existing channel unit.

In the embodiment shown in FIG. 1, the channel units 140a-c and their corresponding storage units 150a-c provide data storage functionality for the system. A channel unit in the embodiment shown in FIG. 1 comprises a server having one or more software processes executing to provide data channel functionality. For example, in one embodiment, a server executes a software application to enable the server to communicate with a controller 130 and a transport 120. The server may further be in communication with one or more storage units 150. The software application may allow the server to receive requests from a transport 120 to store data or to retrieve data blocks or parity blocks. The software application may further be configured to allow the server to access storage locations on a storage unit 150.

In the embodiment shown, each channel unit 140a-c is in communication with one storage unit 150a-c. The storage units 150a-c comprise a redundant array of inexpensive disks (RAID) and provide redundant data storage functionality for each channel unit. While the embodiment shown in FIG. 1 comprises a RAID level-5 configuration, any RAID configuration may be used. Alternatively, there may not redundant data storage devices within each storage unit 150a-c. For example, in one embodiment, a data storage device 150 may comprise a single hard disk, a partition on a single hard disk, or a directory within a file system on a single hard disk.

In some embodiments, a channel unit 140 may be in communication with a plurality of storage units 150. For example, in one embodiment, to provide additional redundancy or fault-tolerance, a channel unit 140 may be in communication with two data storage units 150, wherein the two data storage units comprise a primary data storage unit and a secondary data storage unit. In such an embodiment, the secondary data may provide a backup storage device 150 that mirrors data from the primary storage device, and may be employed if the primary storage device fails or is made unavailable, such as for maintenance.

Each channel unit 140a-c, in the embodiment shown in FIG. 1, is configured to receive data blocks and parity blocks from the transport 120 and to store all of the received blocks, data and parity, in a single file. The file thus comprises both data and parity blocks that are stored in the order in which they were received. In another embodiment, channel units 140a-c are configured to store data and parity blocks in separate files. For example, in such an embodiment, a channel unit 140 creates two files, one having data blocks and the other having parity blocks. This may allow the channel unit to only transmit data blocks to the transport 120 when the file is to be retrieved from the system 100. However, if needed, the channel unit 140 can transmit the parity block file to the transport for use in correcting errors or recovering lost or corrupted data blocks.

In the embodiment shown in FIG. 1, use of the Internet as a part of the network 170 in the system 100 may allow components of the system to be located in geographically distant locations. For example, the client 110 may be located in Washington, D.C, while the transport 120 and controller 130 may be located in a data center in Greensboro, N.C. Each channel unit 140a-c and corresponding storage unit 150a-c may be located in a different geographic location as well. For example, in one embodiment, channel unit 140a and storage unit 150a may be located in Singapore, channel unit 140b and storage unit 150b may be located in Germany, and channel unit 140c and storage unit 150c may be located in Canada. However, in other embodiments, network 170 may comprise a local area network (LAN), such as a corporate LAN, or a corporate WAN. In such an embodiment, the channel units 140a-c and storage units 150a-c may be located in a business data center. The caching server 160 may further be located in a different geographic location, or may be operated by a third party. For example, in the embodiment shown, the caching server 160 is operated by Akamai Technologies, Inc.

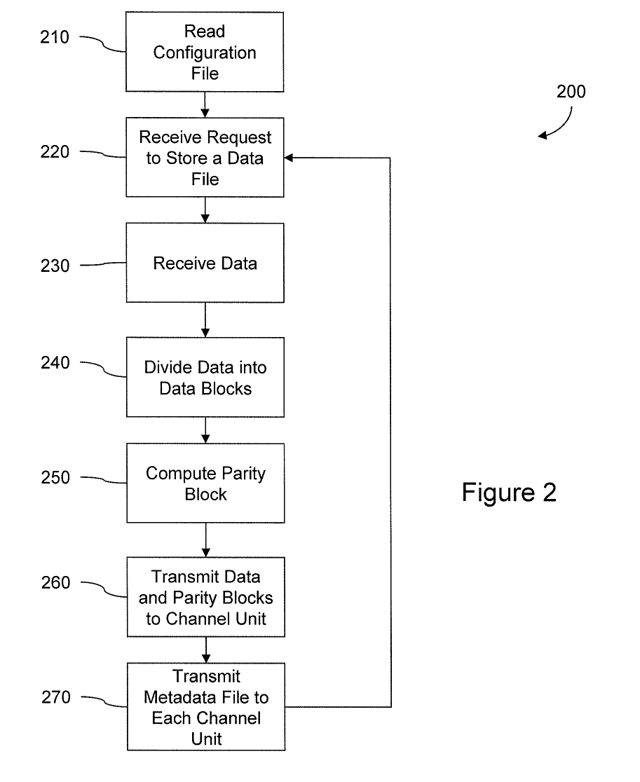

Referring now to FIG. 2, which shows a flowchart 200 for a method of providing redundant data storage according to one embodiment of the present invention, the method begins with step 210. The method of FIG. 2 will be described with respect to the system of FIG. 1.

In step 210, the transport 220 determines a configuration of the system 100. For example, the transport reads a configuration file. In this embodiment, the configuration file may comprise configuration information specifying an IP address for each controller 130, an IP address for each transport 120 (if the system includes a plurality of transports), and an IP address for each channel unit 140a-c in the system 100. In one embodiment of the present invention, the configuration file may comprise additional information, such as status information associated with components of the system. For example, the configuration file may comprise information describing whether each channel unit 140a-c is available or unavailable for read or write access. In one embodiment of the present invention, the configuration file may include parameters used by the system 100 to store data with the channel units 140a-c. For example, the configuration file may comprise system parameters describing the size of data blocks to use, the method for allocating data blocks to channel units 140, or whether to use parity blocks for error correction as well as redundancy.

In one embodiment of the present invention, a configuration file is stored as an extensible markup language (XML) file. For example, an XML configuration file may be similar to the following:

```
<Configuration>
    <Controller>
        <ID>C1</ID>
        <IP>10.1.1.20</IP>
        <Port>8001</Port>
        </Controller>
    <TransportServers>
        <Transport><ID>T1</ID><IP>10.1.1.10</IP>
        <Port>8002</Port></Transport>
        <Transport><ID>T2</ID><IP>10.1.1.11</IP>
        <Port>8003</Port></Transport>
    </TransportServers>
    <DataChannels>
        <Chnl><ID>DC1</ID><IP>10.1.1.1</IP>
        <Port>8011</Port><Status>UP</Status></Chnl>
        <Chnl><ID>DC2</ID><IP>10.1.1.2</IP>
        <Port>8012</Port><Status>UP</Status></Chnl>
        <Chnl><ID>DC3</ID><IP>10.1.1.3</IP>
        <Port>8013</Port><Status>UP</Status></Chnl>
    </DataChannels>
    <SystemParameters>
        <DataBlockSize>1024</DataBlockSize>
    </SystemParameters>
</Configuration>
```

In step 220, the transport 120 receives a signal comprising a request to store a data file. For example, the transport 120 may receive a request to store a data file from a client computer 110. The transport 120 may accept the request to store the data file, or it may deny the request. For example, if there is insufficient storage space within the system 100, the transport 120 may deny the request.

In one embodiment of the present invention, the system 100 may comprise a plurality of transports 120. In such an embodiment, a request to store a data file may be received by a transport 120, and forwarded on to a controller 130. The controller 130 may then transmit the request to a transport 120 that is idle, or to a transport 120 handling the fewest number of data transfers, or to a transport handling a number of transfers below a threshold. In such an embodiment, the system 100 may be able to perform load balancing.

If the system 100 accepts the request to store the data file, the method proceeds to step 230.

In step 230, the transport 120 receives the data file to stored. In one embodiment of the present invention, a transport 120 receives a data file from a client device. In one embodiment of the present invention, the transport 120 may receive a data stream of indeterminate length. For example, the transport 120 may receive a video feed from a client device, such as a security camera. In such a scenario, the amount of data to be stored may not be known at the time the request is sent.

In step 240, the transport 120 generates a plurality of data blocks comprising portions of the file. In one embodiment of the present invention, the size of the data blocks is based on a parameter within the configuration file. For example, the data block size may be determined by the DataBlockSize parameter in the sample configuration file shown above. However, in one embodiment, the number of bytes in a file (or the number of remaining bytes in the file) may be less than DataBlockSize times the number of data channels. In such a scenario, the data block size may be calculated as the number of remaining data bytes divided by the number of channel units minus one. If this calculation does not result in an integer result, the result is rounded up, and padding bytes are added to the end of the remaining data bytes. The newly calculated data block size is then used for the remaining data in the file.

In step 250, the transports 120 computes a plurality of parity blocks based at least in part on the plurality data blocks. Parity blocks may be used by embodiments of the present invention for data redundancy and/or for error correction. For example, in one embodiment, a transport 120 computes parity blocks based on the data blocks by computing the exclusive-OR (“XOR”) of a series of consecutive data blocks. The number of data blocks used to compute a parity block in this embodiment is one less than the number of channel units 140 in the system 100. For example, in a system 100 having six channel units 140, a parity block is computed by XORing five consecutive data blocks (e.g. data blocks 1-5). The next parity block is computed by XORing the next five data blocks (data blocks 6-10), and so forth. Thus, a parity block in this embodiment allows the recovery of any one lost data block. In one embodiment, parity blocks can be computed as data is received. For example, a new parity block can be computed on the fly for every five data blocks received. In one embodiment, the transport receives an entire data file before creating the data blocks and parity blocks.

In step 260, the transport 120 transmits at least some of the plurality of data and parity blocks to the channel units 140a-c. The data and parity blocks are assigned to the channel units such that they are spread across the channel units 140a-c within the system 100. In this embodiment, each group of data blocks and its corresponding parity block is referred to as a “stripe.” There are many ways to assign data and parity blocks to channel units according to various embodiments of the present invention. For example, in one embodiment, parity blocks are assigned to channel units according to the following formula:

channel unit=((S−1) % C)+1, where S=Floor[(P/(DataBlocksize*(C−1))]

P=byte position within the data file

C=number of channel units to be used to store the data file

S is the data stripe number

% is the modulo operator

‘Floor’ refers to the mathematical ‘floor’ function that returns the greatest integer value that is less than or equal to the input value.

In an embodiment employing the channel unit determination function described above, one block (data and/or parity) is sent to each channel unit 140a-c in the system 100 (also referred to as a “write” to a channel unit 130), beginning with channel unit 1. This series of transmissions constitutes a data stripe. Once all of the blocks in a data stripe have been sent, a new stripe begins, and the next set of blocks (data and/or parity) is sent to the appropriate channel units 140. Stripes thus are logical groups of writes to channel units 140 used to determine how parity blocks are to be positioned within the sequence of data blocks. In this embodiment, each stripe contains one parity block and C−1 data blocks. For example, in an embodiment with 3 channel units, each data stripe comprises 2 data blocks and 1 parity block, the parity block generated from the 2 data blocks within its stripe.

Additionally, such an embodiment allows the pre-calculation of which channel unit any arbitrary parity block should be written, even before all of the data blocks have been received from the client device. Thus, in one embodiment of the present invention in which parity is calculated as data blocks are received, it is possible for the transport to assign data blocks to the proper channel units, and afterwards calculate the parity block and assign it to the appropriate channel unit. For example, in one embodiment, a parity block is computed from five data blocks (in an embodiment having six available channels), and the parity block is determined to be assigned to channel 3. As data blocks 1-5 are received, they can be immediately written to channel units 1, 2, 4, 5, and 6, respectively. After the fifth data block as been received, the parity may be calculated, and then the parity block may be written to channel unit number 3.

For example, in one embodiment of the present invention having three channel units 140, a data file having 5,120 bytes is sent to the transport 120 by a client device. In this embodiment, the transport is configured to use a data block size of 1,024 bytes. Because the system has three channel units, parity is computed based on pairs of data blocks. Given the above scenario, the transport would distribute the file as follows:

| | | |
|---|---|---|
| Data Channel | Bytes | Parity Bytes |

Stripe 1

| | | |
|---|---|---|
| DC1 | | [1-1024] |
| DC2 | [1-1024] | |
| DC3 | [1025-2048] | |

Stripe 2

| | | |
|---|---|---|
| DC1 | [2049-3072] | |
| DC2 | | [1025-2048] |
| DC3 | [3073-4096] | |

Stripe 3

| | | |
|---|---|---|
| DC1 | [4097-4608] | |
| DC2 | [4609-5120] | |
| DC3 | | [2049-2560] |

In the embodiment described above, a parity block and each of the data blocks used to compute the parity block are stored to a different channel unit 140. Thus, if any one of the channel units fails, all of the lost data blocks may be regenerated. While this embodiment protects against the loss of a single channel unit, it is possible to use a different parity algorithm to guard against the loss of more than one channel unit. It is possible to guard against the loss of all but one channel unit by mirroring the data on each channel unit and storage unit. However, such an embodiment uses storage space greater than or equal to the number of channel units in the system times the size of the data file to be stored.

In one embodiment of the present invention, the transport 120 is configured to handle the failure of a channel unit while a data file is being stored. If a channel unit 140 fails before or while a data file is being stored, the transport 120 modifies its configuration file to indicate that a channel unit is down. In one embodiment, the transport 110 may also send a notification message to an administrator of the system 100 to the controller 130. The data file is then written (or continues to be written) as though the missing channel unit 140 were still available, though data is not actually sent to the failed channel unit 140. For example, in the embodiment described in the table above, if channel unit 2 failed, data would still be written to channel units 1 and 3 as normal, however, any writes to channel unit 2 would be skipped, but not re-allocated to a different channel unit 140. The following table shows the data written in such a scenario.

| | | |
|---|---|---|
| Data Channel | Bytes | Parity Bytes |

Stripe 1

| | | |
|---|---|---|
| DC1 | | [1-1024] |
| DC2 | | |
| DC3 | [1025-2048] | |

Stripe 2

| | |
|---|---|
| DC1 | [2049-3072] |
| DC2 | |
| DC3 | [3073-4096] |

Stripe 3

| | | |
|---|---|---|
| DC1 | [4097-4608] | |
| DC2 | | |
| DC3 | | [2049-2560] |

In some embodiments, if a channel unit that is to be written to is unavailable, if an alternate channel unit is available, it may be used instead. For example, in one embodiment, a system for redundant data storage comprises 4 channel units. In such an embodiment, a transport may employ 3 of the channel units for storing a particular data file. The transport may detect, while attempting to store data blocks and parity blocks that one of the 3 channel units has become unavailable. The transport may then use the unused channel unit in place of the unavailable channel unit. If the unavailable channel unit becomes available again, the transport may transfer the data from the 4^{th} channel unit, or it may simply disregard the recovered channel unit for the remaining blocks for the data file.

In addition to transmitting the data and parity blocks to the channel units 140a-c for storage, the system 100 may also compress and/or encrypt the data and/or parity blocks. For example, data compression may be desirable to reduce the space consumed by the data blocks on the storage devices 150a-c. Encryption of data blocks and/or parity blocks may be desirable to prevent unauthorized access to data residing on the storage devices 150a-c. Additionally, channel units 140a-c may be configured to respond only to requests from specific IP addresses such as the IP address of the transport 120. Compression and/or encryption may be applied to either the entire data file before it is broken up into blocks, or they may be applied to the individual blocks by a channel unit 140a-c before being stored on the storage units 150a-c.

After the data and parity blocks have been transmitted to the channel units 140, the method proceeds to block 270 in which a metadata file is transmitted to each channel unit 140. In one embodiment of the present invention, the transport 120 writes a metadata file to each channel unit 140. The metadata file describes how the data and parity blocks were allocated to the channel units 140. In one embodiment, the metadata file comprises an XML file that includes information about the data received from the client device, such as the original file size, the original file name, and the data channels used to store the data file. In addition, other data may be stored as well, such as whether file was successfully stored, or data block sizes. For example, a metadata file for the 5,120 byte data file example above may be structured as follows:

```
<FileSummary>
    <FileName>7231R.tmp</FileName>
    <FileSize>5120</FileSize>
    <Complete>YES</Complete>
    <RedundancyLevel>Optimal</RedundancyLevel>
    <DataChannels>
        <Chnl><ID>DC1</ID><IP>10.1.1.1</IP>
        <Port>8011</Port><Status>UP</Status></Chnl>
        <Chnl><ID>DC2</ID><IP>10.1.1.2</IP>
        <Port>8012</Port><Status>UP</Status></Chnl>
        <Chnl><ID>DC3</ID><IP>10.1.1.3</IP>
        <Port>8013</Port><Status>UP</Status></Chnl>
    </DateChannels>
</FileSummary>
```

Once the metadata file has been stored, the method 200 has completed, and may return to block 220 to receive a new request to store data. While the method 200 described with respect to FIG. 2 only included a single request to store a file, embodiments of the present invention may handle more than one request to store data simultaneously.

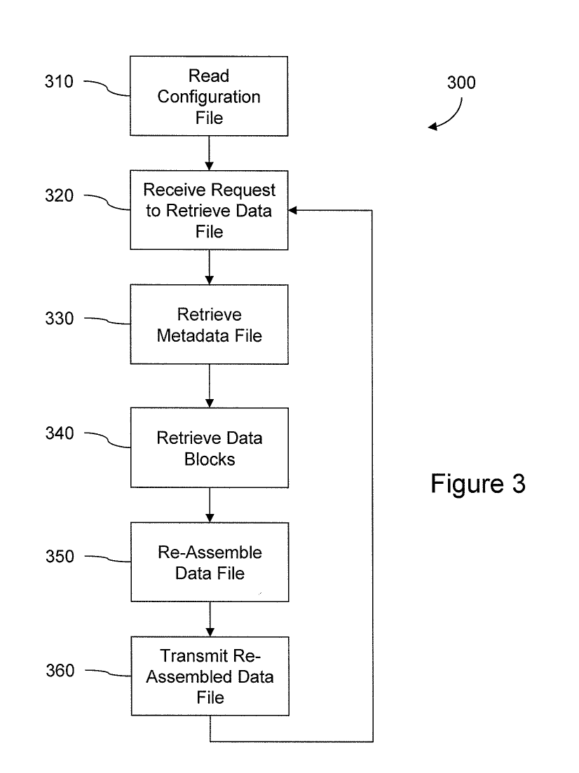

Referring now to FIG. 3, a method for retrieving data from a system 100 for providing redundant storage is shown. In step 310, the transport 120 determines a configuration of the redundant storage system. For example, the transport 120 reads a configuration file. For example, in one embodiment of the present invention, a transport 120 reads the configuration file, such as the configuration file described above with respect to FIG. 2. After reading the configuration file, the method moves to step 320.

In step 320, the transport 120 receives a signal comprising a request to retrieve a data file. The system 100 determines whether the request can be processed. For example, in one embodiment, the transport 120 may determine whether the requested file is stored within the system 100, or if the client is authorized to access the file. If the file is stored within the system 100 and can be retrieved, the method proceeds to step 330.

In step 330, the transport 120 retrieves a metadata file associated with the data file from the channel units 140a-c. In one embodiment of the present invention, a transport 120 retrieves a metadata file from the channel unit 140. In such an embodiment, the transport 120 uses the metadata file to determine which channel units can retrieve the data blocks and parity blocks. Once the metadata has been parsed and the locations of the data blocks and parity blocks have been determined, the data may be retrieved.

In step 340, the transport 100 transmits a signal to the channel units 140a-c requesting the data blocks from the channel units 140. In one embodiment, the transport 120 requests data blocks from the channel units 140 identified in the metadata file. If all of the channel units 140 specified in the metadata file are available, only data blocks are retrieved; the parity blocks are skipped. However, if one of the channel units 140 is unavailable (or become unavailable while data is being retrieved), the configuration file is modified to indicate that the channel unit 140 is unavailable, and the data file is re-assembled using the data and parity blocks from the remaining available channel units 140. In one embodiment, all data and parity blocks are requested, regardless of whether a channel unit is unavailable. In such an embodiment, the parity blocks may be used for error correction or to recover corrupted data.

In one embodiment of the present invention, the data blocks are requested sequentially from the channel units 140 in order from first to last. However, in one embodiment, the system retrieves data blocks from multiple channel units substantially simultaneously. In some embodiments, the data blocks may be retrieved in any order from one or more channel units substantially simultaneously.

Once the transport 120 begins receiving data blocks, it may begin to re-assemble the requested data file.

In step 350, the transport 120 re-assembles the requested data file from the data blocks retrieved from the channel units 140a-c. If data blocks are retrieved out of order, the transport 120 must re-order the data blocks appropriately. For example, in one embodiment, data blocks and parity blocks may comprise metadata, such as a stripe or block number, that may allow the transport to determine how to incorporate the data block into the data file. If one of the channel units 140a-c fails or is unavailable, the transport 120 must regenerate any data blocks stored on the missing channel unit 140. The system may regenerate the missing data block by retrieving the parity block associated with the missing data block, and XORing the parity block with the data blocks from the same stripe. The regenerated data block may then be inserted into the proper place in the re-assembled file.

In step 360, the transport 120 transmits the data file to the client computer 110. In one embodiment of the present invention, the system 100 may also store the re-assembled data file in a cache. For example, if a data file has been requested several times over a short period of time, it may be advantageous to keep the fully re-assembled file in memory on a transport 120 so that the file need not be retrieved from the storage units 150 the next time it is requested. Further, for files that are accessed very frequently, it may be possible to transmit those files to a content provider, such as through a service provided by a third party, such as Akamai Technologies, to provide faster access to the file. Requests for the file made to the system 100 may then be routed to the appropriate third-party server.

Once step 360 has completed the method returns to step 320 and, the system 100 may receive a request to retrieve another data file. While the method 300 described with respect to FIG. 3 only included a single request to retrieve a file, embodiments of the present invention may handle more than one request to retrieve data simultaneously.

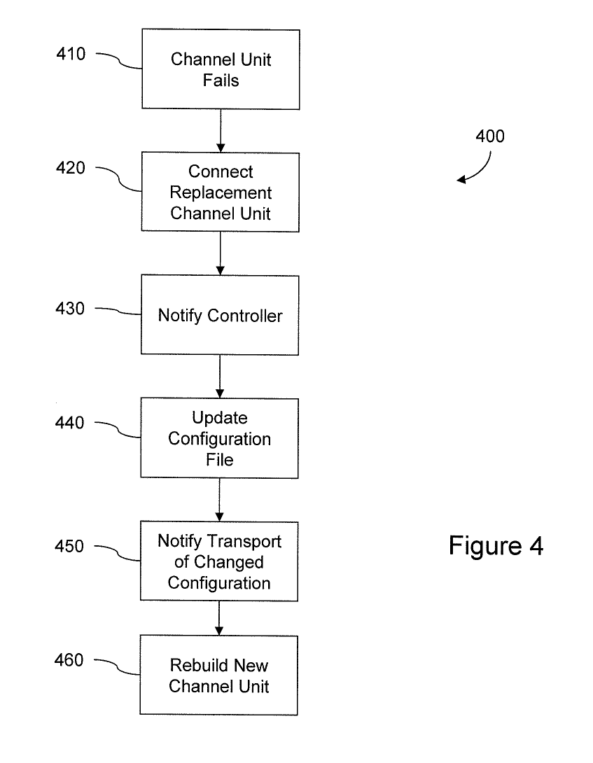

Referring now to FIG. 4 which shows a method for handling the failure of a channel unit within a system for providing redundant storage according to one embodiment of the present invention. In step 410, the failure of a channel unit is detected. For example, a server providing channel unit functionality or storage unit functionality may fail or otherwise stop working, or a storage device within the storage unit 150 may fail, rendering the data on the server unusable. In such a situation, the system 100 determines that the channel unit has failed. For example, the channel unit may transmit a message to the controller 130 indicating the failure, or the channel unit may stop responding to requests from the system 100. In one embodiment of the present invention, system 100 may notify an administrator that the channel unit has failed. The controller 130 also sets a system status flag to indicate degraded redundancy performance.

In step 420, a new channel unit is connected to the system 100. For example, in one embodiment of the present invention, a new channel unit may be connected to the system 100 or the failed channel unit may be repaired. In one embodiment of the present invention, a new channel unit 140 may be connected to the system 100 at a different geographic location than the failed channel unit 140.

In step 430, the controller 130 is notified that the new channel unit has been connected to the system 100. For example, in one embodiment, the new channel unit may transmit a message to the controller 130 indicating that it has been connected to the network. In one embodiment of the present invention, an administrator may manually inform the controller 130 that a new channel unit has been connected to the system 100.

In step 440, the configuration files on the one or more of the transports 120 within the system are updated. For example, in one embodiment of the present invention, the controller 130 generates a new configuration file based at least on part on the new channel unit, and distributes it to each of the transports 120 in the system 100. In one embodiment of the present invention, an administrator may manually configure each transport 120.

In step 450, the controller 130 notifies each transport 120 that the system configuration has changed. For example, in one embodiment, the controller 130 sends a message to the transports 120 indicating that the system configuration has changed. In one embodiment, the controller 130 saves the configuration file to a specific location on each transport 120 for updated configuration files. In such an embodiment, the transport 120 may periodically poll the location to see if a new configuration file is available. When a transport is notified that a new configuration file is available, it will read the new configuration file and operate using the new system configuration. Once the new channel unit is connected to the network 130 and the transports 120 have been updated, the new channel unit is immediately available to transports 120 to write new data files. However, any data files that already exist in the system 100 must be rebuilt on the new control unit 140.

In step 460, the system 100 rebuilds the lost data blocks on the new channel unit 140. In one embodiment of the present invention, the transport 120 regenerates all of the data blocks lost on the failed channel unit 140 and storage unit 150. The transport 120 regenerates the lost data blocks by accessing the data files on each of the other channel units and their associated storage units 150 in the system, copying all of the metadata files to the new channel unit 140 and storage unit 150. The files containing data blocks and parity blocks are rebuilt using the corresponding files from the other channel units 140. For example, in one embodiment, the data and parity blocks within the files on the other channel units 140 are XORed according to the algorithm for recovering lost data blocks above, and the regenerated data is stored on the new channel unit 140 and associated storage device 150. Once all of the lost data blocks are regenerated, the transports 120 are notified. The controller 130 resets the system status to indicate optimal redundancy, and the system 100 may retrieve data from the new control unit 140.

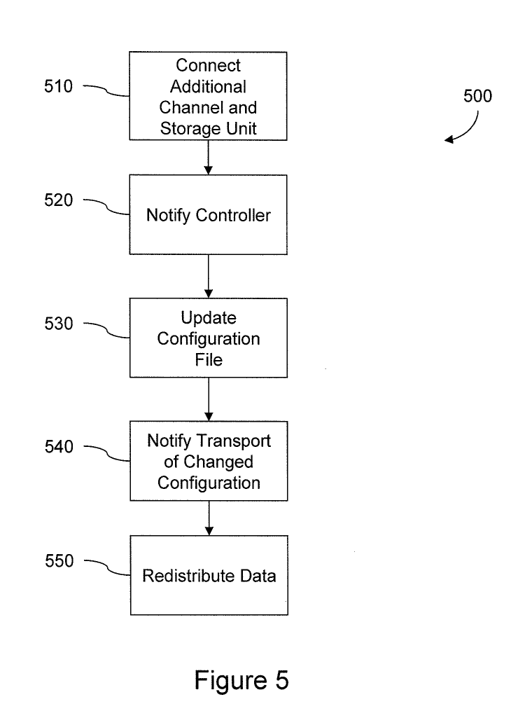

Referring now to FIG. 5, a method for connecting an additional channel unit 140 and storage unit 150 to a system 100 according to one embodiment of the present invention is shown. In step 510, a new channel unit 140 and storage unit are connected to the system 100. In this scenario, a channel unit 140 has not failed, but rather, an additional channel unit 140 and associated storage unit 150 are added to the system 100.

In step 520, the controller 130 is notified that a new channel unit 140 has been added to the system 100. For example, in one embodiment of the present invention, the new channel unit 140 sends a message to the controller 130 indicating that it has been connected to the system 100. In one embodiment, an administrator manually configures the controller 130 with information about the new channel unit 140.

In step 530, the configuration files on one or more of the transports 120 within the system 100 are updated. For example, in one embodiment of the present invention, the controller 130 generates a new configuration file and distributes it to each of the transports 120 in the system 100. In one embodiment of the present invention, an administrator may manually configure each transport 120.

In step 540, the controller 130 notifies each transport 120 that the system configuration has changed. For example, in one embodiment, the controller 130 sends a message to the transports 120 indicating that the system configuration has changed. In one embodiment, the controller 130 saves the configuration file to a specific location on each transport 120 for updated configuration files. In such an embodiment, the transport 120 may periodically poll the location to see if a new configuration file is available. When a transport 120 is notified that a new configuration file is available, it reads the new configuration file and operates using the new system configuration. update the configuration files on each transport 120, and notify each transport 120 that the system configuration has changed. Once the additional channel unit 140 and storage unit 150 is connected to the network 130 and the transports 120 have been updated, the new channel unit 140 is immediately available to transports 120 to write new data files.

In step 550, some or all of the data stored within the system 100 is redistributed to make use of the new channel unit 140 and storage unit 150. In one embodiment of the present invention, the controller redistributes the data. To ensure availability of existing files during this process, the new files are written to a temporary file location until they are complete. Then the old data files and metadata files are replaced, as long as the file is not being read. If the file is being read by one of the transports 120, the controller 130 waits to do the file replace until the read is complete. In some embodiments, the old data files are not modified and the new configuration is only used for new data files stored in the system 100.

The embodiments described above refer to the various components of the system. Each of the components of a system for providing redundant storage comprise a software application. Further, the components shown in FIG. 1 may not exist as separate physical computer systems, but may be combined into one or more computers or processor-based devices. For example, in one embodiment of the present invention, a server may execute program code to perform the functionality of a transport 120 and to perform the functionality of a controller 130.

In one embodiment of the present invention, a system for providing redundant data storage may comprise standard desktop computers within a local area network. A first computer may execute an application comprising program code providing transport 120 functionality. The first computer may also execute an application comprising program code providing controller 130 functionality. The system further comprises three standard desktop workstations connected to the local area network. Each of the desktop workstations executes an application comprising program code providing channel unit 140 functionality. Within each desktop workstation, a portion of an internal storage device, such as a hard drive, may be allocated as a storage unit 150. For example, each desktop workstation may have an internal hard drive configured with a partition to function as a storage unit 150. In one embodiment, each desktop workstation may have a directory within a file system on a storage device allocated to function as a storage unit 150. Using such an embodiment, redundant storage may be provided cheaply and easily using existing hardware within a local area network by installing the appropriate application software. New channel units 140 and storage units 150 may be added by installing application code on additional desktop workstations. Further, multiple systems for providing redundant storage may be configured within the same local area network.

Embodiments of the present invention may provide additional redundancy by employing redundant storage within the storage units 150. For example, in one embodiment of the present invention, each storage unit 150 may comprise redundant storage, such as by using a standard redundant array of inexpensive disks (RAID) configuration. Further, each storage unit 150 may itself be a system according to one embodiment of the present invention.

Embodiments of the present invention provide additional redundancy and fault tolerance by allowing channel units 140 and storage units 150 to be located in different geographic locations. For example, a first channel unit 140 and first storage unit 150 may be located in North Carolina; while a second channel unit 140 and second storage unit 150 may be located in California; and a third channel unit 140 and third storage unit 150 may be located in Germany. By providing redundant storage spread across geographically distant control and storage units, a system may be made tolerant to local disruptions to power or network connectivity.

Referring again to FIG. 1, embodiments of the present invention can be implemented in digital electronic circuitry, or in computer hardware, firmware, software, or in combinations of them. In one embodiment, a computer 101 may comprise a processor 110 or processors. The processor 110 comprises a computer-readable medium, such as a random access memory (RAM) coupled to the processor. The processor 110 executes computer-executable program instructions stored in memory 111, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage or transmission device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other forms of computer-readable media may transmit or carry instructions to a computer, such as a router, private or public network, or other transmission device or channel. The processor, and the processing, described may be in one or more structures, and may be dispersed through one or more structures. The processor may comprise code for carrying out one or more of the methods (or parts of methods) described herein.

### General

The foregoing description of embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the invention.

That which is claimed is:

1. A system, comprising:
a first transport;
a first controller in communication with the first transport;
a first channel unit in communication with the first transport; and
a first storage unit in communication with the first channel unit.

2. The system of claim 1, wherein the first channel unit comprises a plurality of channel units, and wherein the plurality of channel units are each in communication with the transport.

3. The system of claim 1, further comprising a plurality of channel units, and wherein the first transport is configured to:
receive a first signal comprising a request to store a file;
determine a storage configuration of a redundant storage system;
receive the file;
generate a plurality of data blocks comprising portions of the file;
compute a plurality of parity blocks based at least in part on the plurality of data blocks; and
transmit at least some of the plurality of data blocks and at least some of the plurality of parity blocks to the channel unit.

4. The system of claim 3, wherein the first transport is further configured to compute the plurality of parity blocks by computing an exclusive-OR value of a first data block and a second data block from the plurality of data blocks.

5. The system of claim 4, wherein the first and second data blocks are consecutive data blocks from the plurality of data blocks.

6. The system of claim 4, wherein the exclusive-OR value is computed from n data blocks, where n is the number of channel units in the communication with the transport minus one.

7. The system of claim 6, wherein the plurality of data blocks and the plurality of parity blocks are assigned to one of the plurality of channel units according to the formula: channel unit=((stripe number−1) % number of channel units used)+1, wherein ‘stripe number’=Floor [(byte position/(data block size*(number of channel units−1))].

8. The system of claim 1, wherein the first controller is configured to transmit a storage configuration to the first transport.

9. The system of claim 1, further comprising a plurality of channel units.

10. The system of claim 9, wherein at least one of the plurality of channel units is geographically distant from the other of the plurality of channel units.

11. The system of claim 1, wherein the first storage unit comprises a redundant array of inexpensive disks.

12. The system of claim 1, wherein the transport is in communication with a caching server and is configured to transmit a file to the caching server.

13. The system of claim 1, wherein the first controller is configured to:
maintain information for accessing the first channel unit,
detect the addition of additional channel units,
detect the removal or failure of the first channel unit, and
determine the status of the first channel unit.

14. A method, comprising:
receiving a first signal comprising a request to store a file;
generating a plurality of data blocks comprising portions of the file;
computing a plurality of parity blocks based at least in part on the plurality of data blocks; and
transmitting at least some of the plurality of data blocks and at least some of the plurality of parity blocks to a channel unit.

15. The method of claim 14, wherein determining a storage configuration of a redundant storage system comprises receiving a controller signal from a controller, the controller signal comprising the storage configuration associated with channel units in communication with a transport, the storage configuration comprising a number of channel units, information for accessing the channel units, and the status of the channel units.

16. The method of claim 14, further comprising generating a metadata file and transmitting a metadata signal to the channel unit, the metadata signal comprising the metadata file.

17. The method of claim 14, wherein computing the plurality of parity blocks comprises computing an exclusive-OR value of a first data block and a second data block from the plurality of data blocks.

18. The system of claim 17, wherein the first and second data blocks are consecutive data blocks from the plurality of data blocks.

19. The system of claim 17, wherein the exclusive-OR value is computed from n data blocks, where n is the number of channel units in the communication with the transport minus one.

20. The system of claim 14, wherein the plurality of data blocks and the plurality of parity blocks are assigned to one of a plurality of channel units according to the formula: channel unit=((stripe number−1) % number of channel units used)+1, wherein ‘stripe number’=Floor [(byte position/(data block size*(number of channel units−1))].

21. A method, comprising:
receiving a first signal comprising a request to retrieve a file;
identifying at least one channel unit in communication with a storage unit comprising at least one data block or at least one parity block associated with the file;
transmitting a signal to the at least one channel unit requesting the file;
receiving at least one data block or at least one parity block from the channel unit;
generating the file based at least in part on the at least one data block or at least one parity block; and
transmitting the file to the client.

22. The method of claim 21, further comprising transmitting a metadata signal to the at least one channel unit requesting the metadata file, and receiving the metadata file.

23. A computer-readable medium comprising program code, the program code comprising:
program code for receiving a first signal comprising a request to store a file;
program code for determining a storage configuration of a redundant storage system;
program code for generating a plurality of data blocks comprising portions of the file;
program code for computing a plurality of parity blocks based at least in part on the plurality of data blocks; and
program code for transmitting at least some of the plurality of data blocks and at least some of the plurality of parity blocks to a channel unit.

24. The method of claim 23, further comprising generating a metadata file and transmitting a metadata signal to the channel unit, the metadata signal comprising the metadata file.

25. The method of claim 23, wherein computing the plurality of parity blocks comprises computing an exclusive-OR value of a first data block and a second data block from the plurality of data blocks.

26. The system of claim 23, wherein the plurality of data blocks and the plurality of parity blocks are assigned to one of a plurality of channel units according to the formula: channel unit=((stripe number−1) % number of channel units used)+1, wherein ‘stripe number’=Floor [(byte position/(data block size*(number of channel units−1))].

27. A computer-readable medium comprising program code, the program code comprising:
program code for receiving a first signal comprising a request to retrieve a file from a client;
program code for identifying at least one channel unit in communication with a storage unit comprising at least one data block or at least one parity block associated with the file;
program code for transmitting a signal to the at least one channel unit requesting the file;
program code for receiving at least one data block or at least one parity block from the channel unit;
program code for generating the file based at least in part on the at least one data block or at least one parity block; and
program code for transmitting the file to the client.
